(19) United States
(12) Patent Application Publication
(10) Pub. No.: US 2009/0050422 A1
(43) Pub. Date: Feb. 26, 2009

(54) GROOVED DISC BRAKE ROTOR

(75) Inventors: Brad Malott, Brighton, MI (US); Gang Lou, Rochester, MI (US)

Correspondence Address: DOBRUSIN & THENNISCH PC, 29 W LAWRENCE ST, SUITE 210, PONTIAC, MI, 48342, US

(73) Assignee: AKEBONO CORPORATION (NORTH AMERICA)

(21) Appl. No.: 11/843,985

(22) Filed: Aug. 23, 2007

(51) Int. Cl. F16D 65/12

(52) U.S. Cl. 188/218 XL

(57) ABSTRACT

The present invention is predicated upon a disc brake rotor, being made up of a rotor hat and at least one disc having a thickness including a peripheral wall having at least one groove configuration defined therein that extends over a predetermined arc segment of the peripheral wall for the purpose of changing the natural frequency of the rotor.

### FIELD OF THE INVENTION

The present invention is predicated upon systems and methods for improving brake rotors and more specifically reduction of vibration and noise generated thereby during operation.

### BACKGROUND OF THE INVENTION

Brake vibration and resulting noise therefrom has long been a common problem for brake suppliers and vehicle manufacturers. This vibration and noise is a source of customer dissatisfaction resulting in warranty costs and loss of future sales. With respect to brake rotor systems, sliding contact between the pads and rotor during brake operation may excite the rotor to vibrate in various modes. These modes may be tangential (e.g. in-plane) or normal (e.g. out-of-plane) with respect to the friction surfaces of the rotor disc. These modes are mainly influenced by the rotor geometry, and to a lesser extent the surrounding components and suspension of the vehicle system. Historically manufacturers would modify this by changing the vanes for stiffness, the thickness of the plates or adding a dampening band.

For packaging and thermal performance, the geometry of the rotors, particularly the friction plates, is generally fixed. This invention thus pertains to designing the rotor to influence its response to excitation within the design limits imposed by packaging and thermal performance.

Examples of efforts in the art toward rotor design are found in U.S. Pat. Nos. 6,193,023; 6,454,958; and 6,655,508; all incorporated by reference herein.

### SUMMARY OF THE INVENTION

The present invention seeks to improve on prior brake systems and particularly to change the natural frequency of the rotor to fall within a predetermined target frequency thereof by providing an improved rotor design having groove features located about the outer edge of the rotor disc. In one aspect, the present invention provides a machined brake rotor. In another aspect, the present invention provides a cast brake rotor. The rotor, whether machined or cast, includes a disc consisting essentially of a single solid disc or plate, or it may include at least a pair of spaced apart plates connected by a plurality of vanes. The groove feature includes a groove profile selectively located on the peripheral wall of the rotor disc or disc plate.

It should be appreciated that the above referenced aspects and examples are non-limiting as others exist within the present invention, as shown and described herein.

### BRIEF DESCRIPTION OF THE DRAWINGS

FIG. 1 illustrates a side view of an illustrative example of the present invention.

FIG. 2 illustrates a side view of an illustrative example of standard single disc plate disc brake rotor, unmodified according to the present invention.

FIG. 3 illustrates a side view of a second illustrative example of the present invention.

FIG. 4 illustrates a side view of a multiple illustrative examples of the groove profiles of the present invention.

FIGS. 5 through 8 are graphical representations of exemplary expected frequency results of one illustrative example of the present invention.

### DETAILED DESCRIPTION

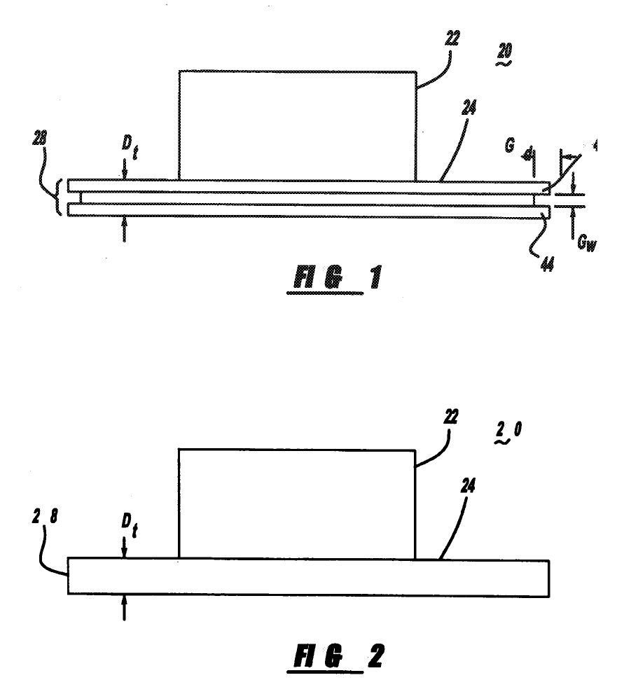

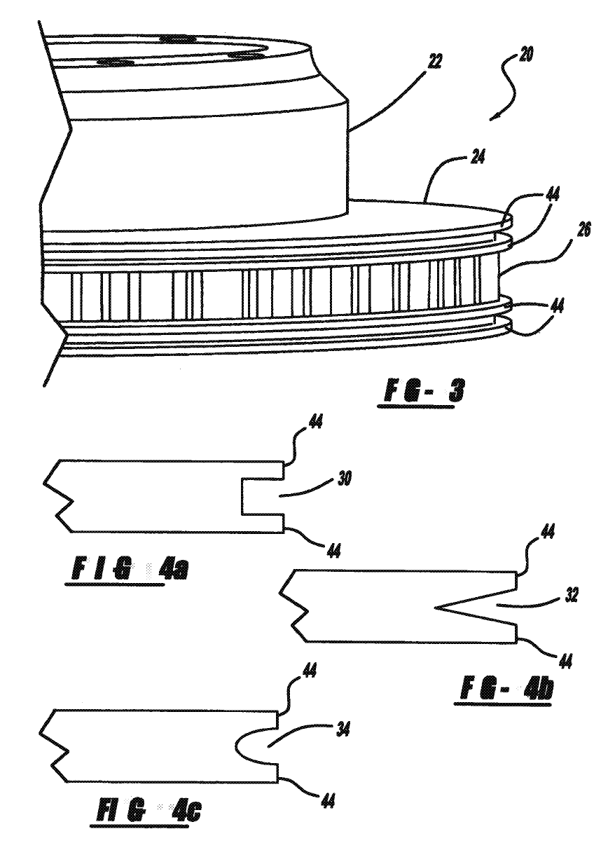

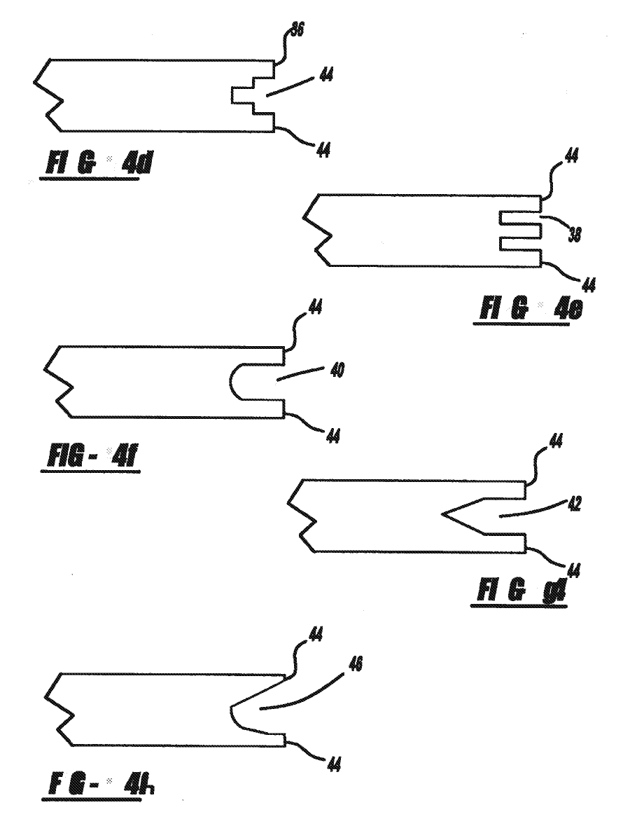

The present invention is directed at an improved disc brake rotor 20 particularly one that includes a rotor hat 22 and at least one disc 24 as seen in FIGS. 1-3 (with and without the groove feature respectively). The disc may consist essentially of a single disc plate, as shown on the disc 24 of FIG. 2. It may also include a plurality of spaced apart disc plates, as in FIG. 3, which shows plates separated by a plurality of vanes 26. The present invention seeks to improve on prior brake systems and particularly to change the natural frequency of the rotor so that it will fall within a predetermined target frequency. Each natural frequency has an associated vibration mode shape, these mode shapes may be tangential (e.g. in-plane) or normal (e.g. out-of-plane) with respect to the friction surfaces of the disc 24. This is accomplished by providing an improved rotor design having groove features located about the outer edge of the rotor disc and without the need to add a separate dampening band, or dampening insert, as in Published U.S. application No. 2006/0076200. Thus, in service, the grooves of the invention herein are unfilled. Additionally, this is accomplished while substantially avoiding rotor fatigue, maintaining acceptable rotor stiffness and increasing the heat dissipation potential of the rotor through increased surface area.

It is contemplated that the disc 24 may consist essentially of a single solid disc or plate, as seen in FIGS. 1-2, or it may include at least a pair of spaced apart plates connected by a plurality of vanes 26 as seen in FIG. 3. Each plate 24, whether used in a disc with single plate or a multiple plate/vane construction, may have an overall thickness of at least about 3.0 to 20.0 mm and will include a peripheral wall 28.

It is contemplated that the peripheral wall(s) 28 of the plate(s) 24 may have a generally flat profile about the 360° disc arc except in at least one predefined arc segment wherein there is at least one groove configuration defined therein. For embodiments that include plural plates separated by vanes, on multiple plate/vane constructions, it is contemplated that at least one if not more than one of the plates 24 will have at least one peripheral groove defined in at least one of the plates.

Generally, it is contemplated that a particular groove configuration is disposed about the peripheral wall in one or more multiple discrete groove segments. Which may span the entirety of the peripheral wall, or only a portion. For example, separated by arc segments with a flat profile (e.g. defined by the peripheral wall), a different groove configuration, or any combination thereof. In one embodiment, there may be at least two groove arc segments, spaced about angularly equidistant from each other along the disc arc, and comprise at least about 7.5° of the 360° arc each. In another embodiment, there may be at least three groove arc segments, spaced about angularly equidistant from each other along the disc arc, and comprise at least about 5.00 of the 360° arc each. Whether the groove segment is contained in a single area or in multiple areas (e.g. two, three or more areas) along the disc arc, it is preferable that the total grooved arc segment or segments comprise at least about 150 of the 360° arc, more preferably at least about 30° of the 360° arc, and most preferably at least about 600 of the 360° arc. In some instances, it is contemplated that the grooved arc segment may be located around the complete 360° of the peripheral wall 28 of the plate 24.

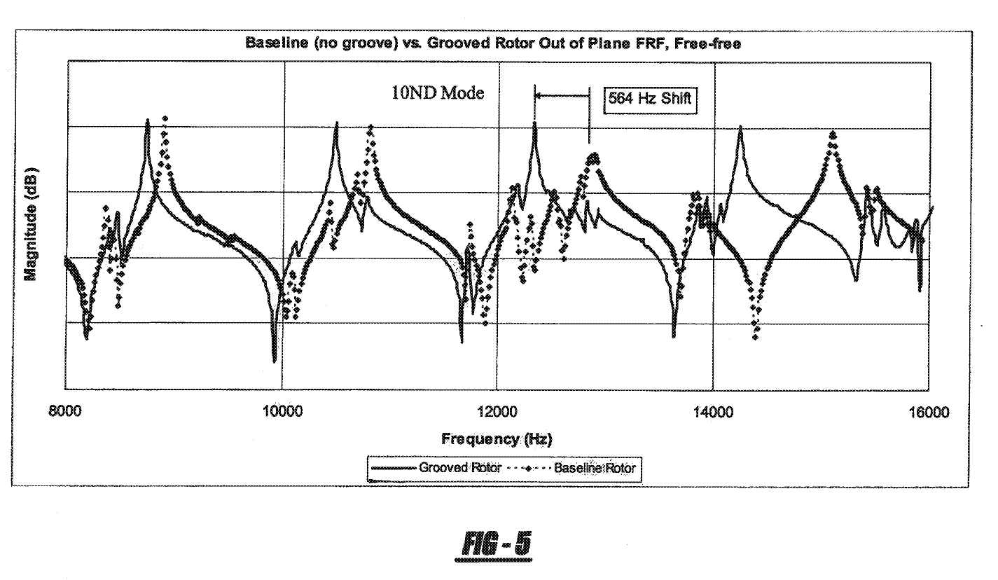

Various groove configurations and locations within the peripheral wall 28 of the plate 24 may be employed. The profile of the groove can be a variety of differing shapes and sizes. As illustrative examples, in FIG. 4, the groove can have a square profile 30, a triangular profile 32, a rounded profile 34, a stepped profile 36, multiple grooves 38 with similar or differing profiles, or any combination thereof. The profile relative to the peripheral wall 28 can also include a portion with a flat side wall, an arcuate side wall, a flat bottom, an arcuate bottom, a portion substantially resembling a U-shape 40, a portion substantially resembling a V-shape 42, or any combination thereof.

The depth of the groove G_{d}, is measured from the outer edge of the peripheral wall moving towards the rotational axis of the disc to its deepest point. The preferable depth ranges from about 2.0 to 10.0 mm, more preferably from about 2.5 to 7.0 mm and even more preferably from about 3.0 to about 6.0 mm.

Depth of at least one of the grooves can also be calculable based upon the thickness of the disc 24. For the present invention, it is believed that the greater the depth, the higher the natural frequency shift. Although, a groove that is too deep can potentially cause undesirable stress and fatigue issues. In a preferred embodiment, the ratio of the disc thickness Dₜ to the depth of at least one groove is from about 1.5:1 to 10:1, even more preferably a ratio from about 1.75:1 to 5:1, and most preferably from about 2:1 to 3:1.

The width of the groove G_{w}, is measured as the maximum width of a given groove profile. The invention contemplates that the smaller the width of the groove, along with an appropriate groove depth, the higher potential for frequency separation and a higher stiffness response. The preferable width ranges from about 1.0 to 7.0 mm, more preferably from about 1.25 to 5.0 mm and even more preferably from about 1.5 to 4.0 mm. It is understood that these preferred ranges can vary as the overall thickness of the plate 24 vary from differing disc brake rotor designs.

It is contemplated that the location of the groove, relative to the side walls of the plate 24 can be varied according to the needs of the overall disc brake system. In one embodiment, the groove can be placed generally near the middle of the peripheral wall 28, thereby separating the disc plate periphery into opposing wall portions 44 of nearly equal thickness with a solid center portion (e.g. where the groove is disposed) in-between. In another embodiment, the groove is offset from the center in the peripheral wall 28, thus producing opposing wall portions 44 of differing thickness (e.g. a first opposing wall portion having one thickness and a second opposing wall portion having a second thickness). This differing opposing wall thickness can also be accomplished by using any number of asymmetrical groove profiles, specifically where the asymmetry is calculated about the centerline of the given groove profile, for example as seen in FIG. 4h.

In one preferred embodiment, the disc or plate 24 includes at least one groove configuration with a predetermined groove profile that is sufficient for a relative movement of an out of plane rotor mode frequency versus an in-plane rotor mode frequency by at least about 4%, while substantially avoiding rotor fatigue.

In another preferred embodiment, the disc brake rotor is a unitary structure that is cast to a near net shape including a predetermined groove profile located in the plate's peripheral wall. Subsequent post-casting processing may or may not be required.

In yet another preferred embodiment, the disc brake rotor is machined from separate metallic stock pieces and assembled into a complete disc brake rotor, wherein the groove feature is formed by machining the groove profile into the plate 24 or plates which form the disc.

In yet a further preferred embodiment, the disc brake rotor is constructed from a combination of machined and cast pieces and the groove feature can be formed by casting, machining, or any combination of these processes.

In an illustrative example, shown in FIG. 1, a generally rectangular groove profile is included in the peripheral wall 28 of a single plate cast iron brake rotor. The groove profile has a groove depth G_{d} of about 5.0 mm and a groove width G_{w} of about 4.0 mm. The groove is located about the center of the peripheral wall 28 and its grooved arc segment circumscribes the entire plate 24.

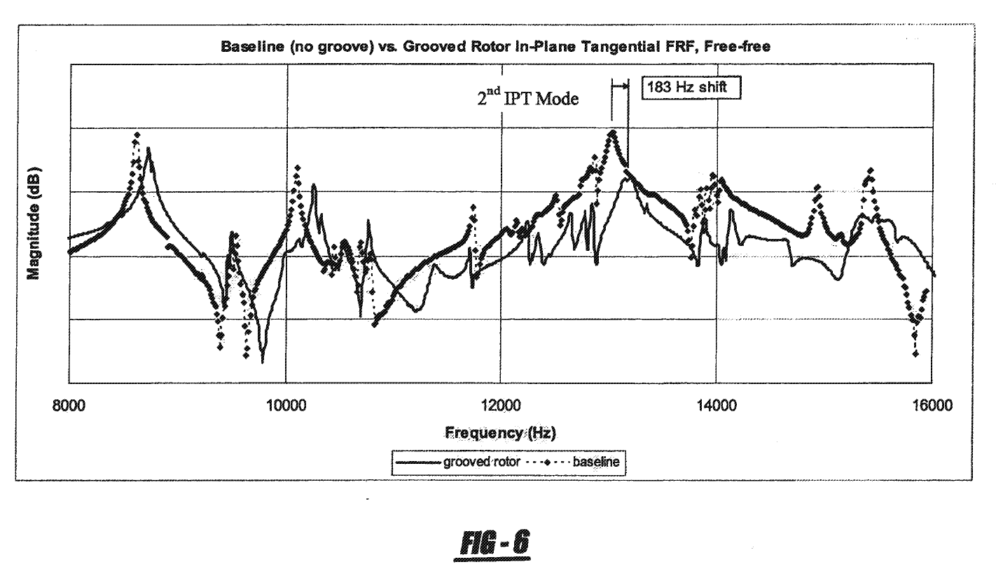

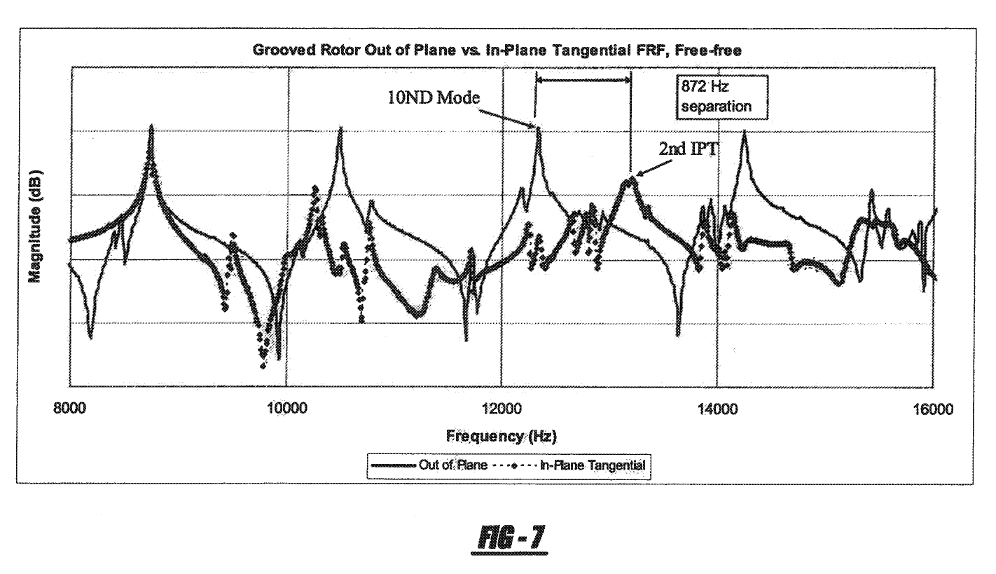

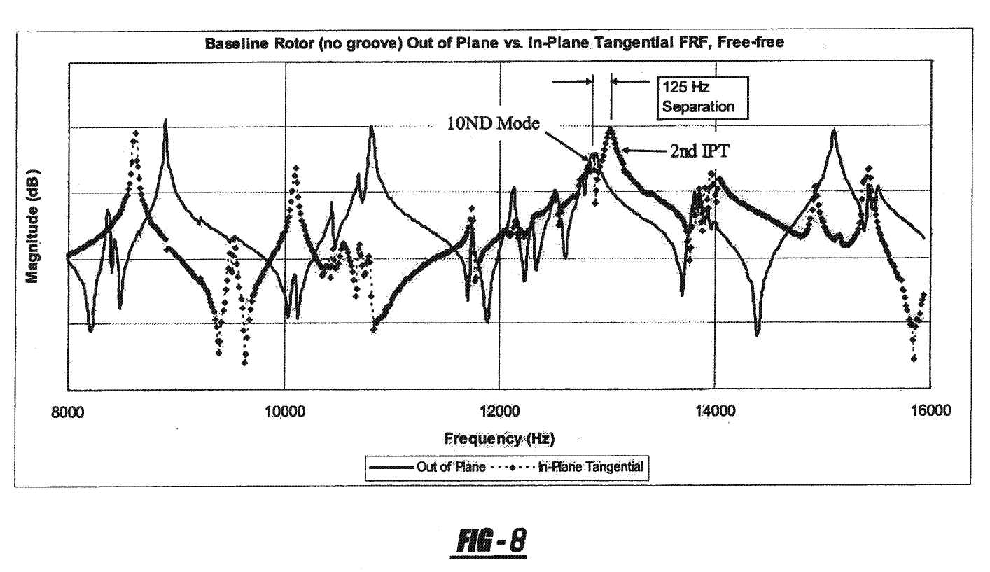

In this same example the frequency response functions (“FRF”) in both the out of plane and in-plane directions are measured prior to the addition of the groove feature and are shown as the “baseline rotor” line in FIGS. 5, 6, 7 and 8. The groove profile is added to the rotor plate and the frequencies are measured again, shown as the “grooved rotor” line in FIGS. 5, 6, and 7. The frequency shift for the out of plane mode (The 10^{th} nodal diametrical mode, labeled as 10ND rotor mode), referring to FIG. 5, is about 564 Hz and the frequency shift for the 2^{nd} in-plane mode (labeled 2^{nd} IPT mode), referring to FIG. 6, is about 183 Hz. Referring to FIG. 7, the in-plane versus the out of plane modes show about an 872 Hz separation, which represents an increase in separation of the two respective modes of about of 750 Hz or about seven times that of the baseline rotor, baseline shown in FIG. 8.

For the present invention, and illustrated in the above example, it is believed that the addition of the groove feature generally decreases the out of plane rotor mode frequency while increasing the in plane rotor mode frequency, thus creating one desirous effect of a larger separation between the respective frequency modes. A separation of up to ten times greater or more than compared with a rotor without the present invention. Another desirous effect that is contemplated by the present invention is achieving a smaller separation between the respective frequency modes by use of the groove feature.

Generally it is known and understood that the environment that the disc brake rotor is located within is sometimes referred to as a corner module for a vehicle. This corner module generally includes; a hub and bearing; a caliper assembly; and the rotor. A knuckle and or one or more suspension components (e.g. a strut or arm) may also be part of the corner module.

Without intending to be bound by theory, it is believed that certain of the noise that is overcome by the present invention is due to a vibration that results from a plurality of frequencies (e.g., at least a first frequency and a second frequency) arising from one or more deformation modes of the rotor 20. The invention thus contemplates a method for designing an automotive vehicle brake for reducing noise contributed by a brake rotor of an automotive vehicle, comprising the steps of identifying at least a first and a second frequency in at least one deformation mode for a rotor having a rotational axis and selectively introducing a groove feature (as taught herein) to the peripheral wall 28 of the disc 24 for achieving frequency shift of at least about 4%.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. The rotor hat 22 and the disc or plate 24 can be either a unitary structure or separate pieces that are assembled together. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A disc brake rotor, comprising:
a rotor hat;
at least one disc attached with the rotor hat, having a thickness including a peripheral wall having at least one groove configuration defined therein that extends over a total arc segment of the peripheral wall of at least 450.

2. A rotor according to claim 1, wherein the at least one groove configuration includes at least one groove having a depth of about 3 to about 6 mm.

3. A rotor according to claim 1, wherein the ratio of the disc thickness to the depth of at least one groove in the groove configuration is from about 1.5:1 to about 5:1.

4. A rotor according to claim 1, wherein the groove extends about the entire periphery.

5. A rotor according to claim 1, wherein at least one groove of the at least one groove configuration extends at least 45 degrees about the peripheral wall.

6. A rotor according to claim 1, wherein the at least one disc consists essentially of a single solid disc, or it includes a pair of spaced apart plates connected by a plurality of vanes.

7. A rotor according to claim 1, wherein at least one groove in the at least one groove configuration separates the peripheral wall into two opposing wall portions of equal thickness or of different thickness.

8. A rotor according to claim 1, wherein the at least one groove configuration includes at least one groove having a profile relative to the peripheral wall including a portion including a flat side wall, an arcuate side wall, a flat bottom, an arcuate bottom, a portion substantially resembling a U-shape, a portion substantially resembling a V-shape, or any combination thereof.

9. A rotor according to claim 1, wherein the at least one groove configuration is sufficient for changing an out of plane rotor mode frequency relative to an in-plane rotor mode frequency by at least 4%, while substantially avoiding rotor fatigue.

10. A corner module including a rotor according to claim 1.

11. A disc brake rotor, comprising:
a rotor hat;
at least one disc attached with the rotor hat, having a thickness including a peripheral wall having at least one groove configuration defined therein that extends over a total arc segment of the peripheral wall of at least 45°, wherein the at least one disc consists essentially of a single solid disc, or it includes a pair of spaced apart plates connected by a plurality of vanes, wherein the at least one groove configuration includes at least one groove having a depth of about 3 to about 6 mm, further wherein at least one groove in the at least one groove configuration separates the peripheral wall into two opposing wall portions of equal thickness or of different thickness.

12. A rotor according to claim 11, wherein the at least one groove configuration includes at least one groove having a profile relative to the peripheral wall including a portion including a flat side wall, an arcuate side wall, a flat bottom, an arcuate bottom, a portion substantially resembling a U-shape, a portion substantially resembling a V-shape, or any combination thereof.

13. A rotor according to claim 12, wherein the at least one groove configuration is sufficient for changing an out of plane rotor mode frequency relative to an in-plane rotor mode frequency by at least 4%, while substantially avoiding rotor fatigue.

14. A rotor according to claim 11, wherein the groove extends about the entire periphery.

15. A corner module including a rotor according to claim 11.

16. A disc brake rotor for a vehicle, comprising:
a rotor hat;
a disc attached with the rotor hat, the disc having a thickness of at least 8.0 mm, including a peripheral wall having at least one groove configuration defined therein having a groove depth of at least 1.5 mm and a groove width of at least 3.0 mm, that extends over a total arc segment of the peripheral wall of at least 450, wherein the disc consists essentially of a single solid disc, further wherein the at least one groove in the at least one groove configuration separates the peripheral wall into two opposing wall portions of equal thickness or of different thickness.

17. A rotor according to claim 16, wherein the at least one groove configuration includes at least one groove having a profile relative to the peripheral wall including a portion including a flat side wall, an arcuate side wall, a flat bottom, an arcuate bottom, a portion substantially resembling a U-shape, a portion substantially resembling a V-shape, or any combination thereof.

18. A rotor according to claim 17, wherein the groove extends about the entire periphery.

19. A rotor according to claim 16, wherein the at least one groove configuration includes at least one groove having a profile relative to the peripheral wall substantially resembling a U-shape.

20. A corner module including a rotor according to claim 18.
